(19) United States
(12) Patent Application Publication
(10) Pub. No.: US 2003/0217859 A1
(43) Pub. Date: Nov. 27, 2003

(54) Switch cover plate preventing unintentional touch of toggle lever of switch

(76) Inventor: Chun-Fu Lin, Ilan (TW)

Correspondence Address: PRO-TECHTOR INTERNATIONAL, 20775 Norada Court, Saratoga, CA, 95070-3018, US

(21) Appl. No.: 10/152,959

(22) Filed: May 21, 2002

(51) Int. Cl. H02G 3/14

(52) U.S. Cl. 174/66

(57) ABSTRACT

A switch cover plate includes an inner recess portion, a wall portion rising relative to and enclosing the inner recess portion, and an outer cover portion surrounding the wall portion. One or more toggle levers of switches are located in the inner recess portion. The inner recess portion has a depth equal to a height of the wall portion and sufficient to cover a height of the toggle levers measured at projected ends thereof. That is, the projected ends of the toggle levers are lower than a plane passing a top of the wall portion without the risk of being easily touched to cause unwanted turning on or off of switches. The inner recess portion gives the switch cover plate a three-dimensional appearance and the outer cover portion may have differently designed contours.

### FIELD OF THE INVENTION

The present invention relates to a switch cover plate, and more particularly to a switch cover plate that prevents unintentional touch of toggle lever of switch located therein and may have differently designed contours.

### BACKGROUND OF THE INVENTION

A conventional switch cover plate 1 is shown in FIG. 1 and generally includes a flat-topped cover 11, on which one or more openings 12 are formed for toggle levers 2 of switches to mount therein. By pushing the toggle lever 2, a corresponding switch is turned on or off to control an electric product, such as a lighting fixture, a machine, etc.

When a toggle lever 2 is mounted in the opening 12 on the switch cover plate 1, one of its two ends 21 is in an upward projected position. A user may push the projected end 21 of the toggle lever 2 to switch the electric product between two using states, for example, from on to off, or from off to on.

Since the conventional switch cover plate 1 has a flat-topped cover 11, the upward projected end 21 of the toggle lever 2 projects from a top surface of the flat-topped cover 11 after the toggle lever 2 is mounted in the opening 12 of the switch cover plate 1, and is easily touched to cause unwanted turning on or off of the switch or even embarrassment or dangerous accident. It is therefore desirable to develop an improved switch cover plate to eliminate the above-mentioned drawbacks.

### SUMMARY OF THE INVENTION

A primary object of the present invention is to provide a switch cover plate preventing unintentional touch of toggle levers mounted therein.

To achieve the above and other objects, the switch cover plate of the present invention mainly includes an inner recess portion, a wall portion rising relative to and enclosing the inner recess portion, and an outer cover portion surrounding the wall portion. One or more toggle levers of switches are located in the inner recess portion. The inner recess portion has a depth equal to a height of the wall portion and sufficient to cover a height of each toggle lever measured at a projected end thereof. That is, the projected end of the toggle lever is lower than a plane passing a top of the wall portion without the risk of being easily touched to cause unwanted turning on or off of the switch. The inner recess portion gives the switch cover plate a three-dimensional appearance and the outer cover portion may have differently designed contour, making the switch cover plate changeful and practical for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional switch cover plate;

FIG. 2 is a perspective view of a switch cover plate according to a first embodiment of the present invention;

FIG. 3 is a perspective view of a switch cover plate according to a second embodiment of the present invention; and

FIG. 4 is a perspective view of a switch cover plate according to a third embodiment of the present invention.

### DETAILED DESCRIPTION OF THE PREFERRED EMBODIMENTS

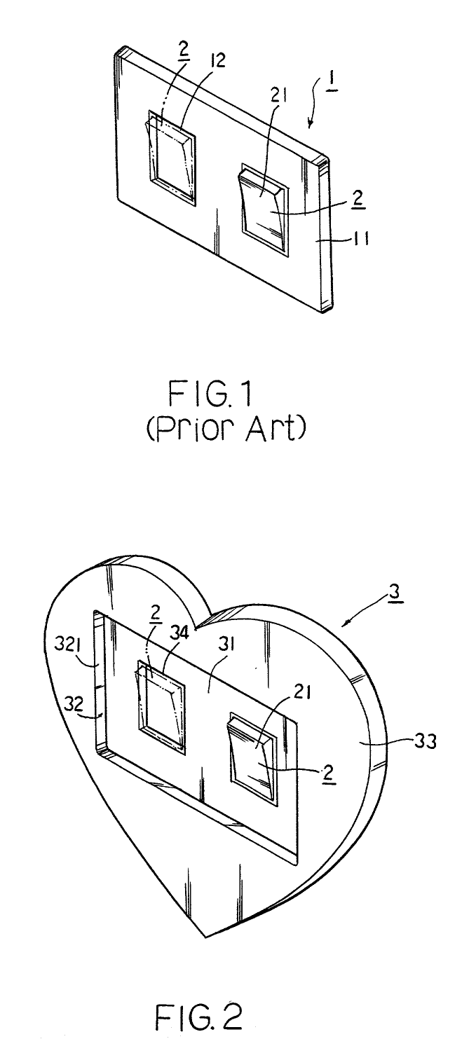

Please refer to FIG. 2 that is a perspective view of a switch cover plate 3 according to a first embodiment of the present invention. As shown, the switch cover plate 3 includes an inner recess portion 31, a wall portion 32 rising relative to and enclosing the inner recess portion 31, and an outer cover portion 33 surrounding the wall portion 32. One or more openings 34 are provided in the inner recess portion 31 for toggle levers 2 of switches to locate therein and project an end 21 therefrom. More specifically, the toggle levers 2 are located in an area within the inner recess portion 31, and the inner recess portion 31 has a depth equal to a height of the wall portion 32 and to sufficiently cover a height of the toggle levers 2 measured at the projected ends 21 thereof. That is, the projected ends 21 of the toggle levers 2 do not project from a plane passing a top of the wall portion 32. Thus, the wall portion 32 provides effective protection to prevent the projected ends 21 of the toggle levers 2 in the recess portion 31 from being easily touched by someone or something to cause unwanted depression of the toggle levers 2 unless they are purposefully depressed.

The inner recess portion 31 may be formed in many ways. In the first embodiment shown in FIG. 2, the inner recess portion 31 is formed by way of providing within the outer cover portion 33 with vertically downward extended surfaces 321, which form the wall portion 32 and define the inner recess portion 31.

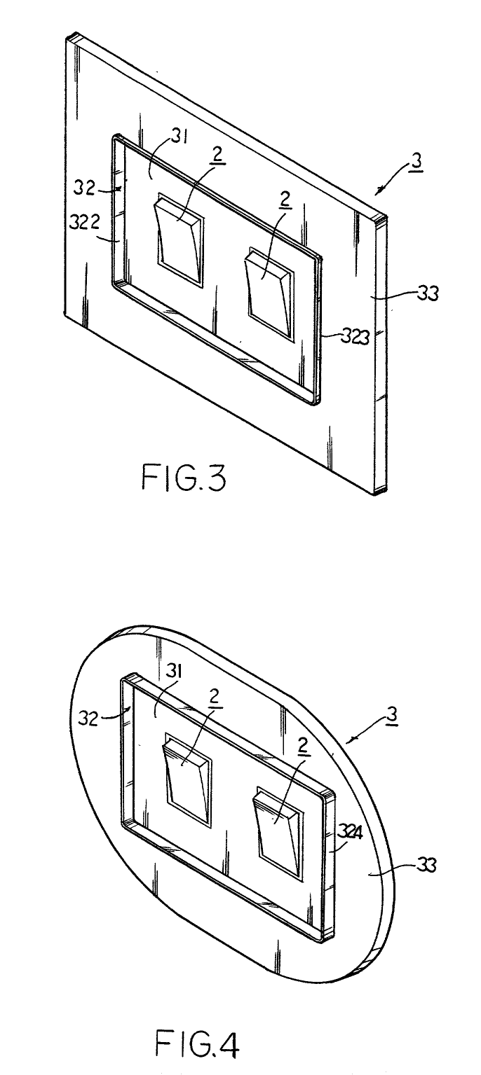

FIG. 3 is a perspective view of a switch cover plate 3 according to a second embodiment of the present invention. In this embodiment, the inner recess portion 31 is formed by way of providing within the outer cover portion 33 with vertically downward extended surfaces 322 and a flange 323 integrally upward extended from a top of the surfaces 322. The downward extended vertical surface 322 and inner surfaces of the upward extended flange 323 together form the wall portion 32 and define the inner recess portion 31.

FIG. 4 is a perspective view of a switch cover plate 3 according to a third embodiment of the present invention. In this embodiment, the inner recess portion 31 is formed by way of providing within a top surface of the outer cover portion 33 with a vertically upward extended flange 324, which forms the wall portion 32 and defines the recess portion 31 therein.

With the inner recess portion 31, the whole switch cover plate 3 has a three-dimensional top surface. From the standpoint of the inner recess portion 31, there is always an outer cover portion 33 on the switch cover plate 3 surrounding the inner recess portion 31. The outer cover portion 33 may be differently designed to show different contours for mounting at different places. For example, the outer cover portion 33 may have artistic shapes to show graceful air for use in living rooms, offices, or meeting rooms; or fruit or vegetable shapes to arouse appetite for use in dining rooms or kitchens; or romantic shapes to create harmonious air for use in bedrooms; or cartoon shapes to attract children for use in studies or playrooms. The switch cover plate 3 with the inner recess portion 31 and the changeful outer cover portion 33 not only provides safety in use of toggle levers 2 of switches but also creates beautiful and pleasant visions in our living environments.

What is claimed is:

1. A switch cover plate preventing unintentional touch of toggle levers of switches, comprising an inner recess portion, a wall portion rising relative to and enclosing said inner recess portion, and an outer cover portion surrounding said wall portion; said switch cover plate being provided within an area of said inner recess portion with one or more openings, within each of which a toggle lever of a switch is mounted to normally project one of two ends from said inner recess portion; and said inner recess portion having a depth equal to a height of said wall portion and sufficient to cover a height of said toggle levers measured at said projected ends, that is, said projected ends of said toggle levers being lower than a plane passing a top of said wall portion without the risk of being easily touched to cause unwanted turning on or off of switches corresponding to said toggle levers.

2. The switch cover plate as claimed in claim 1, wherein said inner recess portion is formed by providing within said outer cover portion with vertically downward extended surfaces which form said wall portion and define said inner recess portion.

3. The switch cover plate as claimed in claim 1, wherein said inner recess portion is formed by providing within said outer cover portion with vertically downward extended surfaces and a flange integrally upward extended from a top of said vertically downward extended surfaces; and said vertically downward extended surface and inner surfaces of said upward extended flange together form said wall portion and define said inner recess portion.

4. The switch cover plate as claimed in claim 1, wherein said inner recess portion is formed by providing on a top surface of said outer cover portion with a vertically upward extended flange which forms said wall portion and defines said inner recess portion.
